(19) United States
(12) Patent Application Publication
(10) Pub. No.: US 2026/0159775 A1
(43) Pub. Date: Jun. 11, 2026

(54) A METHOD FOR OBTAINING ALL THE ACTIVE INGREDIENTS IN OLIVE FRUIT

(71) Applicant: MEDICAL FARM ILAÇ VE SAGLIK ÜRÜNLERI SANAYI VE TICARET LIMITED SIRKETI, Osmangazi, Bursa (TR)

(72) Inventor: Ilhan SARI, Osmangazi, Bursa (TR)

(21) Appl. No.: 18/708,862

(22) PCT Filed: Jul. 20, 2023
(86) PCT No.: PCT/TR2023/050708

§ 371 Date: May 9, 2024

(51) Int. Cl. C11B 1/10

(52) U.S. Cl. CPC C11B 1/10

(57) ABSTRACT

Disclosed is a production method for obtaining all of the vitamins and minerals in olive fruit as powder or semi-fluid for use in cosmetics, pharmaceuticals, food, food supplements, etc. sectors. In particular, disclosed is a production method that prevents the extraction of olive black water in the extraction of olive oil and enables the extraction of all of the active ingredients in olives from waste olive pomace as powder or semi-fluid.

### TECHNICAL FIELD

The invention relates to a production method for obtaining all of the vitamins and minerals in olive fruit as powder or semi-fluid for use in cosmetics, pharmaceuticals, food, food supplements, etc. sectors.

In particular, the invention relates to a production method that prevents the extraction of olive black water (wastewater) in the extraction of olive oil and enables the extraction of all of the active ingredients in olives from waste olive pomace as powder or semi-fluid.

### KNOWN STATE OF THE ART

Olive, a member of the Oleaceae family, is a species of tree whose fruit is eaten, which is traditionally native to the Mediterranean climate. The olive fruit consists of epicarp (fruit skin/shell), mesocarp (fruit flesh) and endocarp (fruit kernel). The water content in olives is 50% on average and it contains 1.6% protein, 20% fat, 20% carbohydrate, 5-6% cellulose and 1.5% ash. The olive fruit contains important and beneficial compounds; the main compounds are water, fatty compounds, simple sugars, other carbohydrates, proteins, pectins, organic acids, tannins, oleuropein, colorants, vitamins and inorganic substances. Approximately 90% of all harvested olives are converted into oil, while about 10% are consumed as table olives. In olive oil extraction, after 20% of the olives are extracted as oil, at least 80% is released as waste.

Depending on the extraction method employed in olive oil extraction, different amounts and contents of pomace, blackwater (wastewater), olive leaves and branches are obtained. The liquid by-product of the olive oil extraction process is called black water and the solid by-product is called pomace. In the classical method, it takes a long time to extract the oil and a large amount of oil is left in the by-products. This results in the loss of oil and compounds. Olive pomace is the part consisting of the peel, pulp and pits left after olive oil extraction. Although the moisture and oil content varies according to the production method, it has an average of 75-80% dry matter, 3-5% crude ash, 35-50% crude cellulose, 5-10% crude protein and 8-15% crude oil content. When we classify the studies carried out in the world to utilize olive oil process wastes, we encounter alternative energy production (biogas, bioethanol, pellets, etc.), agricultural applications (soil conditioner) and livestock (feed) applications.

Today, after olive production, the leaves and the fruit itself are subjected to various processes, for example, the leaf is used as tea, the fruit part is used for table consumption, or the oil is extracted by squeezing and used as olive oil. However, in these processes, the most basic problem we have identified in olive fruit in general is the deterioration of all vitamins and active substances in the olive flesh due to the lack of fast processing. For this reason, pomace and olive black water are formed from the flesh left over when olive oil is pressed, and since these are not recycled and used, they can also cause environmental pollution. For this reason, there is a need for a method to extract the oil from the olive flesh without destroying its vitamin structure and to extract the pomace and make its active ingredients usable.

In the research conducted in the literature, the document numbered 2014/11738 can be shown as an example of the known state of the technique. The mentioned document is related to the utilization method of olive pomace and olive seeds. The said invention comprises the following: seed collector, where the seed collector inlet is positioned with the outlet mouth, sieves located behind the seed collector, the pomace adding chambers positioned on the sieves located in the back row, the filter positioned under the sieves, the separation water collector positioned on the sieves located in the front row, clean water drain which is the first and last part of the closed circuit separation system, seed tank where the seeds are collected after the separation process, pulp water tank where the pomace-water mixture is collected after separation, main water tank where clean water is collected, main water motor on the main water tank, auxiliary separation water motor on the main water tank, 5 hydraulic pumps that pressurize the pressurized water to the screens where the pomace and seeds will be separated with injectors, clean water filters positioned on the clean water drain, a water collector positioned on hydraulic pumps, a pulp water filter to remove particles from the water, a drying vat in which the drums are placed and the seeds are exposed to heat to remove toxic gases, and 3 drying drums positioned inside the drying vat. However, there is no specific mention of a method by which all the active ingredients can be extracted from olives without losing their vitamins.

An example of the known state of the art is document numbered 2012/02654. The said document relates to a method applied to increase the quality and yield of pomace oil in the extraction of oil from pomace, which is the solid by-product remaining after the olives are mechanically converted into oil in olive oil production. However, the invention does not specifically mention preventing the olive blackwater from coming out and extracting the oil without disrupting the vitamin structure and extracting the pomace and making the active ingredients usable.

The document numbered 2016/12062 relates to the extraction of pomace oil and triterpenic acid mixture from wet pomace by microwave technique. In the invention in question, in its most basic form, it is mentioned to obtain a mixture of pomace oil and triterpenic acid (maslinic and oleanolic acid) simultaneously by applying extraction with microwave technique to wet pomace, which is the waste of olive oil facilities. In the invention, it is mentioned that one of hexane, chloroform and petroleum ether is added to the pomace as a solvent and it is used as fuel. In the said invention, there is no mention of a method to obtain all of the active ingredients without losing olive vitamins and use in food products.

Therefore, the existence of the above problems and the inadequacy of existing solutions necessitated a development in the relevant technical field.

### OBJECTIVE OF THE INVENTION

The present invention relates to a production method for obtaining all of the vitamins and minerals contained in the olive fruit in powder or semi-fluid product form, which eliminates the disadvantages mentioned above and provides new advantages to the relevant technical field.

The main objective of the invention is to develop a production method that prevents the formation of olive blackwater waste material, prevents the deterioration of the olive content with rapidly applied processes and enables the extract to be obtained by utilizing the whole product.

The objective of the invention is to obtain all of the active ingredients in olives in powder or semi-fluid form.

An objective of the invention is to develop a method for preventing the formation of liquid waste at the end of olive oil production and for utilizing the pomace formed as a solid by-product.

Another objective of the invention is to ensure that olives containing the active ingredient Oleuropein, minerals such as potassium (K), calcium (Ca), phosphorus (P), sodium (Na), magnesium (Mg), iron (Fe), zinc (Zn), copper (Cu), manganese (Mn) and vitamins B, E are obtained and consumed by making capsules.

A further objective of the invention is to provide a product containing active substances which can be excreted from the human body even if too much is taken.

A further object of the invention is to provide an environmentally friendly, economical method that prevents the generation of waste and the loss of valuable substances.

In order to achieve the objectives described above, the invention is a production method for obtaining a product in powder or semi-fluid form by extracting all of the vitamins, minerals and active substances in olive fruit, and the said method comprises the following process steps;
i. Picking the olives
ii. Extracting the oil within maximum 3-4 hours after picking the olives,
iii. Drying the olive flesh after the oil is extracted,
iv. Transferring of ingredients to water by boiling the dried flesh in ultrapure water under high pressure
v. Obtaining the semi-fluid product by evaporating the water containing the active ingredients by boiling it in an evaporator at a temperature range of 30-45° C.

The structural and characteristic features of the invention and all its advantages will be understood more clearly by means of the detailed description given below. For this reason, evaluation should be made taking into account this detailed explanation.

### DETAILED DESCRIPTION OF THE INVENTION

In this detailed explanation, the preferred alternatives of the subject of invention are explained only in order to better understand the subject and in such a way that they do not create any limiting effects.

The subject matter of the invention is a production method for obtaining a product in powder or semi-fluid form by extracting all of the vitamins, minerals and active substances in olive fruit, and the said method comprises the following process steps;
i. picking the olives
ii. Extracting the oil within maximum 3-4 hours after picking the olives,
iii. Drying the olive flesh after the oil is extracted,
iv. Transferring of ingredients to water by boiling the dried flesh in ultrapure water under high pressure
v. Obtaining the semi-fluid product by evaporating the water containing the active ingredients by boiling it in an evaporator at a temperature range of 30-45° C.

The drying process mentioned in process step iii) of the method of the invention is preferably carried out with low temperature air at a temperature range of 30-45° C., preferably at 45° C. for 3-12 hours. In another embodiment, the said drying process is preferably freeze-dried at −35° C. in order not to lose the vitamin values in the flesh.

Freeze Dry is a method in which freezing is applied first, drying is applied afterwards. In the freeze drying method, which is the most advanced drying method in the world, the frozen food product is sublimated under vacuum. Thus, the moisture content in the food turns directly from a solid to a gaseous state without entering the intermediate liquid state through sublimation. Freeze Dry Technology, also known as lyophilization, is generally used in the storage of fruits and vegetables. In general, it is the freezing and removal of the water content of products at low pressure and temperature without losing their basic structure. In this application, fruits and vegetables are first frozen into ice crystals. Then the temperature is reduced and low pressure is applied. The ice crystals formed are directly converted into water vapor by sublimation. In this way, the amount of moisture in the products is greatly reduced and the products are dried at low temperature.

In an embodiment of the method of the invention, the process of transferring the active ingredients to the water by boiling the dried flesh in ultrapure water under high pressure takes place in a temperature range of 30-45° C., preferably at 35° C., for 12 hours. Here, the dried olive flesh is preferably boiled in ultrapure water under a pressure of 42.3-73.48 Pa in a pressurized boiler.

In an embodiment of the method of the invention; in process step iv), the semi-fluid product is obtained by boiling and evaporating the water containing the active ingredients in the evaporator under a pressure of 42.3-73.48 Pa in a temperature range of 30-45° C., preferably at a temperature of 35° C. Here, the water containing the active ingredients is evaporated by boiling in an evaporator preferably at 45° C. for a maximum of 5 hours and 10 minutes. The viscosity value of the viscous product obtained here is in the range of 45-55, preferably 52.

The method of our invention includes the following steps in summary; Olives grown under certain geographical conditions are picked. Then, oil is extracted within a maximum of 3-4 hours after the olives are picked. The olive flesh after the oil is extracted, is preferably dried at low temperature or by freeze-dry methods. The dried olive flesh is then subjected to an extraction process. This process is preferably carried out under high pressure at 35° C. for 12 hours. At this stage, ultrapure water is used as a carrier and the dried pomace is boiled in this water to transfer all the active ingredients into the water. The water containing the active substances is then evaporated by boiling the water preferably at 45 degrees with pressure differences. The time required for evaporation here is preferably 5 hours and 10 minutes, and if this time is exceeded, the molecules can break down. With the evaporation of water, a semi-fluid product is obtained with a viscosity value in the range of 50-53, preferably 52.

In an embodiment of the method of our invention includes the following steps; olives grown under certain geographical conditions are picked. The olives are then preferably frozen at −35° C. Oil is extracted from the frozen olives at the desired time. The flesh, from which oil is extracted, is dried at low temperature or by freeze-dry methods. The dried flesh is then subjected to an extraction process. This process is preferably carried out under high pressure at 35° C. for 12 hours. At this stage, ultrapure water is used as a carrier and the dried flesh (pomace) is boiled in this water to transfer all the active ingredients into the water. The water containing the active substances is then evaporated by boiling the water preferably at 45 degrees with pressure differences. The time required for evaporation here is preferably 5 hours and 10 minutes, and if this time is exceeded, the molecules can break down. With the evaporation of water, a semi-fluid product is obtained with a viscosity value in the range of 50-53, preferably 52.

In another embodiment of the method of the invention, the semi-fluid product is obtained by boiling and evaporating the water containing the active ingredients at a temperature of 45° C., and then the semi-fluid product is dried with a flash dryer at a temperature range of 35-40° C., preferably at 36° C., for 4-12 hours to obtain a powder form. The powdered product is then preferably made into capsules to obtain a product that can be consumed directly.

Flash dryers are the most economical systems for dry products with an intrinsically low moisture component or dewatered dry products. These systems, also known as pneumatic dryers, make gas suspension. The blades rotating at high-speed blend the product with hot air and turn the product from wet to dry in a short time. It provides mixing, heat and bulk transfer to dry a solid in only one run. It is used when high temperature and physical changes in the particle structure of the product are not a problem after dehydration (drying). Due to the drying of the product in a very short time, the internal structure of the product suffers minimal damage at high temperature. The method of our invention is used due to these features.

1. A production method for obtaining all of the vitamins and minerals and active ingredients in olive fruit in powder or semi-fluid form, characterized by comprising; the following process steps:
i. picking olives,
ii. extracting oil within a maximum of 3-4 hours after picking the olives,
iii. drying the olive flesh after the oil is extracted,
iv. transferring of ingredients to water by boiling the dried flesh in ultrapure water under high pressure, and
v. obtaining a semi-fluid product by evaporating the water containing the active ingredients by boiling it in an evaporator at a temperature range of 30-45° C.

2. The method according to claim 1, wherein the drying process mentioned in the process step iii) is carried out with low temperature air at a temperature range of 30-45° C., preferably at 45° C. for 3-12 hours.

3. The method according to claim 1, wherein the drying process mentioned in process step iii) is carried out by freeze-dry methods at −35° C.

4. The method according to claim 1, wherein in the process step iv), the dried flesh is boiled in ultrapure water under high pressure in a temperature range of 30-45° C., preferably at 35° C. for 3-12 hours.

5. The method according to claim 1, comprising, in process step v), the process of boiling and evaporating the water in the evaporator at a temperature range of 30-45° C., preferably at 35° C. for a maximum of 5 hours and 10 minutes.

6. The method according to claim 1, wherein water containing the active ingredients is evaporated by boiling it in an evaporator under a pressure range of 42.3-73.48 Pa.

7. The method according to claim 1, wherein the viscosity of the fluid product obtained is in the range 45-55, preferably 52.

8. The method according to claim 1, comprising, a process step of obtain obtaining the powder form by drying the semi-fluid product with a flash dryer after the process step v).

9. The method according to claim 8, wherein said drying process is carried out in the temperature range of 35-40° C. for a period of 4-12 hours.

10. The method according to claim 8, comprising; a process of producing capsules from the product in powder form.
